(19) United States
(12) Patent Application Publication
(10) Pub. No.: US 2005/0279290 A1
(43) Pub. Date: Dec. 22, 2005

(54) System and method for animal waste disposal

(76) Inventor: Barry Hyland, Troy, MI (US)

Correspondence Address: HARNESS, DICKEY & PIERCE, P.L.C., P.O. BOX 828, BLOOMFIELD HILLS, MI, 48303, US

(21) Appl. No.: 11/156,296

(22) Filed: Jun. 17, 2005

Related U.S. Application Data
(60) Provisional application No. 60/580,670, filed on Jun. 17, 2004.

(51) Int. Cl. A01K 23/00

(52) U.S. Cl. 119/867

(57) ABSTRACT

An article of manufacture, the article comprising a composition enclosed in a disposable container suited to hold a waste of an animal internally therein, wherein the composition comprises one or more absorbents, the total amount of which is effective to absorb waste moisture.

### CROSS-REFERENCE TO PRIORITY APPLICATION

This patent claims priority to U.S. Provisional Application Ser. No. 60/580,670 (filed Jun. 17, 2004), the entire disclosure of which is incorporated herein by reference.

### FIELD OF THE INVENTION

The present invention relates generally to a system and method for animal waste disposal.

### BACKGROUND OF THE INVENTION

The large quantities of animal waste that accumulate globally present a significant environmental and economic concern for many countries. For example, according to recent estimates, approximately 6.3 billion pounds of dog excrement is produced annually in the United States alone, much of which runs off into waterways and coastal regions. Not only can animal waste increase the risk of spreading disease (e.g., cause an increase in coliform bacteria levels in waterways), but it can also be a public nuisance.

Various animal waste retrieval and disposal products are commercially available. Bags with perfume, bags with shovels or scoops, specially molded bags, miniature toilets, training pants, and litter boxes are some of the products available for disposal of dog waste, for example.

Although a number of animal waste disposal systems have been proposed, such systems have drawbacks including inconvenience, unpleasantness, and ineffectiveness. For example, products involving shovels or scoops can be cumbersome, inconvenient to carry, or embarrassing to the user. Other products can cause an undesirable tactile response during waste retrieval (e.g., when the user grabs the waste with a conventional bag). There remains, therefore, a need for new and alternative systems and methods for animal waste disposal.

### SUMMARY OF THE INVENTION

There is now provided an article of manufacture, the article comprising a pre-measured portion of a composition enclosed in a disposable container suited to hold a waste of an animal internally therein, wherein the composition comprises one or more absorbents, the total amount of which is effective to absorb waste moisture.

There is further provided an article of manufacture, the article comprising a plurality of disposable containers, wherein each container is suited to hold a waste of an animal, wherein each container comprises a pre-measured portion of a composition comprising one or more absorbents, the total amount of which is effective to absorb waste moisture.

There is still further provided a method for disposing a waste of an animal, the method comprising: contacting the waste with a composition enclosed in a disposable container, wherein the composition comprises one or more absorbents, the total amount of which is effective to absorb waste moisture; and placing the contacted waste in the container.

In other embodiments, the present invention provides a pet sanitary bag system having a bag and a material for absorbing moisture and controlling odor adapted for quick and easy collecting of animal feces. The bag has a perforated top for ease of tearing open to access the absorbent material that is dumped onto the feces to cover it, absorb moisture and thereby begins to harden the waste, and minimizes or eliminates odor. This facilitates picking up the waste using the now empty bag which is then ready for disposal.

In some embodiments, the present invention provides a pet sanitary system creating an entirely new method of pet waste collection and management by using an absorbent and odor control material prepackaged in a convenient bag that can then be used to recover the feces and be disposed.

In other embodiments, the present invention provides a sanitation system including a hardening material for hardening feces by creating a “shell” of hardened feces through moisture absorption to facilitate ease of handling, thus avoiding the undesirable tactile response or “squishy” feel associated with waste retrieval.

In some embodiments, the present invention provides an absorbent material for a pet waste sanitation system that creates a barrier around the feces that minimizes or even eliminates odor.

In other embodiments, the present invention provides improved bioactivity of pet waste by accelerating feces degradation through the incorporation of a bio-catalyst component in the absorptive material.

In some embodiments, the present invention provides, a product which protects environment by facilitating improved pick-up compliance by canine owners and walkers.

In other embodiments, the present invention provides a product that facilitates improved convenience by making bag light and small enough to roll-up and place in a back or a coat pocket making it easily accessible to the pet owner/walker.

In some embodiments, the present invention provides a kit comprising a disposable container suited to hold a waste of an animal and a composition comprising at least one absorbent adapted for absorbing moisture of the waste.

Additional advantages and features of the present invention will become apparent from the following description and appended claims, taken in conjunction with the accompanying drawings.

### BRIEF DESCRIPTION OF THE DRAWINGS

The present invention will become more fully understood from the detailed description and the accompanying drawings, wherein:

FIG. 1 is front view of a pet sanitary system constructed in accordance with the teachings of the present invention, a bag of the system shown just prior to being opened.

FIG. 2 is another front view of the pet sanitary system constructed in accordance with the teachings of the present invention, the bag of the system shown after it has been opened and in the process of delivering its contents.

FIG. 3 is a view illustrating the bag of the pet sanitary system inverted from the condition of FIGS. 1 and 2 for waste retrieval.

FIG. 4 is a view of the bag of the pet sanitary system constructed in accordance with the teachings of the present invention shown containing the waste.

### DETAILED DESCRIPTION

The following description of the present invention is merely exemplary in nature and is in no way intended to limit the invention, its application, or uses.

In various embodiments, the present invention provides an article of manufacture, the article comprising a pre-measured portion of a composition enclosed in a disposable container suited to hold a waste of an animal internally therein, wherein the composition comprises one or more absorbents, the total amount of which is effective to absorb waste moisture, and optionally other substances.

The term “waste” herein refers to any substance cast out from the body of an animal including without limitation urine, solid feces, liquid feces, water, stool, body fluids, and vomit. In one embodiment, the waste comprises feces.

The animal can be human or non-human. In various embodiments, the animal is a vertebrate, for example a fish, a bird, a reptile, or a mammal. Illustratively among mammals, the animal can be a member of the order Carnivora, including without limitation canine and feline species. In some embodiments, the animal is a mammal.

In a particular embodiment, the animal is a companion animal. A “companion animal” herein is an individual animal of any species kept by a human caregiver as a pet, or any individual animal of a variety of species that have been widely domesticated as pets, including dogs (Canis familiaris) and cats (Felis domesticus), whether or not the individual animal is kept solely or partly for companionship. Thus “companion animals” herein include working dogs, farm cats kept for rodent control, etc., as well as pet dogs and cats. In one embodiment, the animal is a canine.

The articles and methods of this invention contemplate administration of any of a variety of compositions comprising at least one absorbent. An absorbent is any organic or inorganic substance or material having power, capacity or tendency to absorb or soak up another substance, such as, for example, liquids. One skilled in the art knows that a variety of materials have moisture absorbing capacity.

One skilled in the art knows that in addition to its capacity to absorb another substance, an absorbent can be operative to alter other properties of the waste. For example, a specific type of absorbent also can operate to reduce or eliminate the odor of a waste (e.g., saw dust), alter the texture of a waste (e.g., sand), or directly or indirectly enhance biodegradation of a waste by operating as a bio-catalyst (e.g., alfalfa meal).

In one embodiment, the at least one absorbent is selected from the group consisting of sawdust, alfalfa meal, sand, and mixtures thereof.

In an embodiment, the absorbent, or mixture thereof, is present in the composition in a total amount effective to absorb moisture from the waste. What constitutes an effective amount can vary depending on the species of the animal, the type of waste and other factors. One of skill in the art will, by routine testing based on the disclosure herein, readily establish a total absorbent amount having waste moisture-absorbing effects in any particular situation.

In preparing a composition of the present invention, the at least one absorbent can, for example, be incorporated into the composition during formulation processing, such as during and/or after mixing of other components of the composition. Distribution of these components into the composition can be accomplished by any conventional method including standard mixing procedures.

The composition can, optionally, comprise other components including, without limitation, deodorizers (e.g., sodium bicarbonate), hardeners, and bio-catalysts. The ratio of absorbent to other components can vary significantly. In one embodiment, the composition further comprises sodium bicarbonate. In various embodiments, the absorbent: sodium bicarbonate weight ratio can be about 10 to about 0.1 absorbent to 1.0 sodium bicarbonate, illustratively about 9 to about 0.25, about 8 to about 0.5, about 7 to about 1, about 6 to about 2, or about 5 to about 3 absorbent to 1.0 sodium bicarbonate.

In another embodiment, the composition comprises saw dust, alfalfa meal and sodium bicarbonate. Illustratively, the saw dust:alfalfa meal:sodium bicarbonate weight ration can be about 10 to about 0.1 saw dust, about 10 to about 0.1 alfalfa meal to about 5 to about 0.1 sodium bicarbonate; or about 5 to about 0.5 saw dust to about 5 to about 0.5 alfalfa meal to about 5.0 to about 0.25 sodium bicarbonate; or about 2.5 to about 0.75 saw dust to about 2.5 to about 0.75 alfalfa meal to about 1 to about 0.6 sodium bicarbonate; or about 1:1:0.5.

The term “container” herein refers to any receptacle utilized for containing, storing, packaging, or shipping various objects. Illustratively, a container can be any receptacle, including without limitation a bag, a sack, a box, a cup, a jar, a carton, and a case. Products used in conjunction with a container, that is, products used for containing, storing, packaging, or shipping an object within a container, such as, for example, lids, liners, partitions, wrappers, and/or tools, also are intended to be included within the definition of “container”.

The term “disposable container” herein refers to containers that generally are not intended to be laundered or otherwise restored or reused (i.e., they are intended to be discarded after a single use or a limited number of uses, for example, 10 or less).

The term “biodegradable” herein refers to the ability of an object to decompose into a safe low molecular weight material by the action of living organisms such as microorganisms, fungi, and enzymes in a natural environment or under artificially controlled conditions such as those for making composts.

Illustrative biodegradable containers suitable for use in accordance with the invention are disclosed in the documents individually cited below and incorporated herein by reference.

U.S. Pat. No. 5,178,469 and references disclosed therein.

U.S. Pat. No. 6,524,667 and references disclosed therein.

U.S. Pat. No. 6,878,199 and references disclosed therein.

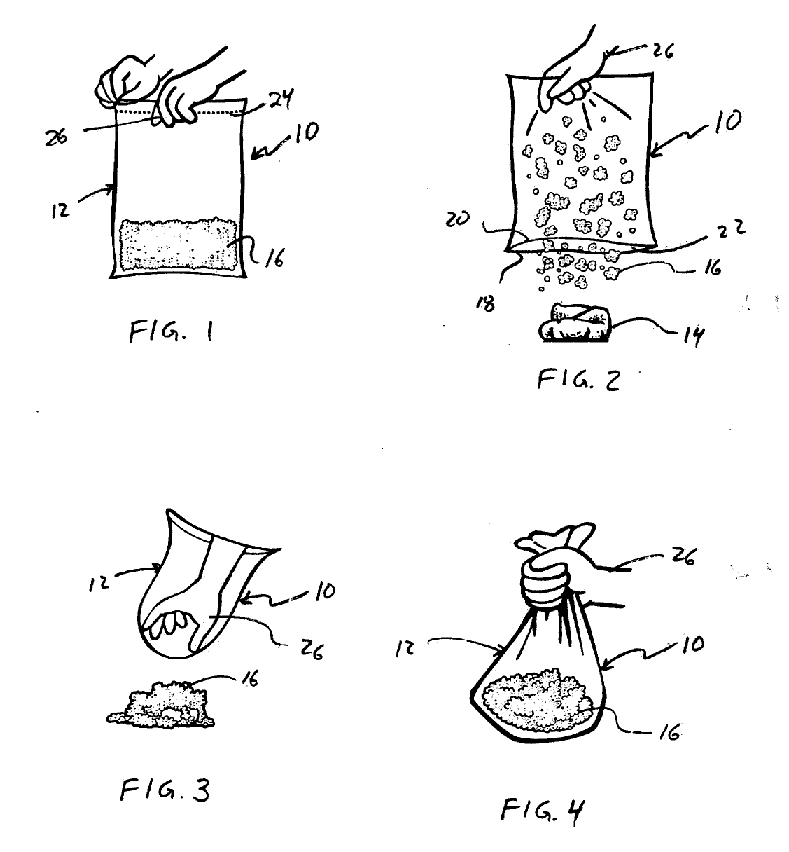

In one embodiment, the container is a bag. In another embodiment, the bag is constructed of a material comprising plastic. In a further embodiment, the bag is a biodegradable bag. In one particular embodiment, a bag is illustrated and generally identified as reference character 12 as shown, for example, in FIG. 1 below.

The amount of composition contained within a container can vary significantly. Generally, the amount of composition in a container is an amount that is sufficient to partially, substantially, or completely cover a waste. In one embodiment, the pre-measured portion is present in the container in an amount of about 0.5% to about 100% of the container by volume, illustratively about 1% to about 90%, about 5% to about 85%, about 10% to about 80%, about 15% to about 75%, about 20% to about 70%, about 25% to about 65%, about 30% to about 60%, about 35% to about 55%, or about 40% to about 50% of the container by volume.

In other embodiments, the present invention provides an article of manufacture, the article comprising a plurality of disposable containers, wherein each container is suited to hold a waste of an animal, wherein each container comprises a pre-measured portion of a composition comprising at least one absorbent in a waste moisture-absorbing effective total absorbent amount, and optionally other substances. The container and the composition are as described above. In some embodiments, each container contains an identical or substantially identical pre-measured portion. In one embodiment, the plurality of disposable containers are joined end to end in a chain.

In some embodiments, the present invention provides a method for disposing a waste of an animal, such a method comprising contacting the waste with a composition enclosed in a disposable container, wherein the composition comprises at least one absorbent in a waste moisture-absorbing effective total absorbent amount and placing the contacted waste in the container. The container and the composition are as described above.

In one embodiment, the method further comprises inverting the bag inside-out subsequent to contacting the waste with the composition.

Subsequent to waste retrieval, the container can be closed using any one of a variety of closure or re-closure methods or systems known to one skilled in the art. In one embodiment, a bag is twisted to a closed condition. In another embodiment, a bag is closed using a wire-type tie or adhesive.

Illustrative re-closure systems suitable for use in accordance with the invention are disclosed in the documents individually cited below and incorporated herein by reference.

U.S. Pat. No. 6,436,500 and references disclosed therein.

U.S. Pat. No. 4,609,107 and references disclosed therein.

U.S. Pat. No. 6,826,808 and references disclosed therein.

U.S. Patent Application No. 2005/0031233 and references disclosed therein.

In yet another embodiment of the invention, a kit comprises a disposable container suited to hold a waste of an animal and a composition comprising at least one absorbent adapted for absorbing moisture of the waste. The kit of this embodiment further comprises a communicating means. The communicating means is attached to or enclosed in the kit. Any suitable form of communicating means can be employed, for example a document such as a label, brochure, advertisement or package insert, a computer-readable digital or optical medium such as a diskette or CD, an audio presentation, for example on an audiotape or CD, or a visual presentation, for example on a videotape or DVD. The communicating means can refer to further information located elsewhere, such as on a website as described above. The communicating means can be provided together with or separately from the package, and can take any suitable form, such as those described above including one or more pages on a website.

In some embodiments, with general reference to FIGS. 1 through 4 of the drawings, a pet sanitary system constructed according to the teachings of the present invention is illustrated and generally identified at reference character 10. The pet sanitary system 10 is shown throughout the drawings to generally include a bag 12 to facilitate the retrieval of pet waste 14. The system 10 is further shown to include a material 16 intended to coat or otherwise cover the pet waste 14.

In the embodiment illustrated, the bag 12 of the pet sanitary system 10 is generally rectangular in shape and has opposing sides 18 and 20 that define a bag interior 22. In one particular application, the bag 12 includes a perforated tear line 24 adjacent one end. The perforated tear line 24 facilitates opening of the bag 12 by a user 26.

In one particular application, the bag 12 is constructed of plastic. The size and shape of the bag 12 may be varied within the scope of the teachings of the present invention. In certain applications, the bag 12 may be constructed of a biodegradable material.

Those skilled in the art, however, will readily appreciate that the bag 12 may be alternatively constructed of other materials having suitable strength and durability characteristics. For example, in one embodiment, the bag 12 can alternatively be constructed of paper. For such an alternative application, it may be desirable to provide a cardboard hang-tag (not shown) stapled to the bag 12 which can be easily torn away and used as an additional device for scooping the waste 14.

The bag 12 is prepackaged to include the material 16. The material 16 may be absorbent, active, or both. The material 16 may be selected from one or more of the following: saw dust; sand; and alfalfa meal. The saw dust is absorbent and will provide odor control. The sand is absorbent and will serve as a hardening agent. The alfalfa meal is absorbent and will serve as a bio-catalyst. It is anticipated that various other items may be used as the material 16 or as part of the material 16. These alternative items will preferably provide absorbency, odor control and/or waste degradation. Such alternative material may include, but are not limited to: any type of saw dust; silica products; clay; recycled newsprint (ground or pellets); shredded paper products; natural minerals (e.g., gypsum, vermiculite, halite, calcite, etc.); composted or organic waste material (e.g., corn cob fines, etc.); salt; corn starch; crushed peanut shells; crushed seashells; peat moss; baking soda; recycled cotton products; straw; pine needles; cat litter; sweeping compound; chalk; absorbent polymers; hemp; bamboo; Maltodextrin; talc; powdered enzymes; cherry granules; cellulose and its byproducts (i.e., methylcellulose, etc.); rice powder; and flour.

According to a first step of a method of the present invention, the bag 12 is opened by tearing at the perforated line 24. In certain applications it may be desirable to provide a metal wire-type tie (not shown) within the portion of the bag 12 torn away for purposes of sealing the bag 12 after it is filled with waste 16. In other applications the bag 12 may be provided with an adhesive strip (not shown) covered by a peel away liner.

According to a second step of the method of the present invention, the material 16 located within the interior 22 of the bag 12 is deposited on the waste 14. The amount of material 16 located within the bag 12 is sufficient to substantially cover the waste 14. The material 16 absorbs moisture from the waste 14, thereby making the texture of the waste 14 more suitable for retrieval.

According to a third step of the method of the present invention, the bag 12 is turned inside-out and the user 26 inserts his or her hand into the inverted bag 12. The material 16 creates a physical and an psychological/emotional barrier between the bag covered hand and the waste 14. The waste 14 and the material 16 covering the waste 14 are retrieved with a claw like action. The bag 12 is then rolled from the user's hand so that the waste 14 and the material 16 are now located within the interior 22 of the bag 12. A simple shake of the bag 12 and its contents will serve to cover any portion of the waste 14 that has not been fully covered.

According to a fourth step of the method of the present invention, the bag 12 is twisted to a closed condition to even further contain any unpleasant odors. As discussed above, the bag 12 may be alternatively closed with a wire-type tie or adhesive. The bag 12 can be pocketed or discretely carried in an odor free manner when the dog walker arrives at the nearest refuse container or even all the way home.

The description of the invention is merely exemplary in nature and, thus, variations that do not depart from the essence of the invention are intended to be within the scope of the invention. Such variations are not to be regarded as a departure from the spirit and scope of the invention. Furthermore, the present invention has been described with reference to a particular embodiment having various features. One skilled in the art will recognize that these features may be used singularly or in any combination based on the requirements and specifications of a given application or design.

All references cited above are incorporated herein by reference in their entirety.

The words “comprise”, “comprises”, and “comprising” are to be interpreted inclusively rather than exclusively.

1. An article of manufacture, the article comprising a composition enclosed in a disposable container, the container suited to hold a waste of an animal internally therein, wherein the composition comprises one or more absorbents, the total amount of the one or more absorbents is effective to absorb moisture from the waste.

2. The article of claim 1, wherein the composition further comprises sodium bicarbonate.

3. The article of claim 2, wherein the composition comprises an absorbent to sodium bicarbonate weight ratio of about 10 to about 0.1

4. The article of claim 1, wherein the one or more absorbent is selected from the group consisting of sawdust, alfalfa meal, sand, and mixtures thereof.

5. The article of claim 4, wherein the composition further comprises sodium bicarbonate.

6. The article of claim 5, wherein the composition comprises an absorbent to sodium bicarbonate weight ratio of about 10 to about 0.1.

7. The article of claim 5, wherein the weight ratio of saw dust to alfalfa meal to sodium bicarbonate in the composition is about 1:1:0.5.

8. The article of claim 1, wherein the container is a bag.

9. The article of claim 1, wherein the composition is present in the container in an amount of about 30% to about 60% of the container by volume.

10. An article of manufacture, the article comprising a plurality of disposable containers, wherein each container is suited to hold a waste of an animal, wherein each container comprises a composition comprising one or more absorbents, the total amount of the one or more absorbents is effective to absorb moisture from the waste.

11. The article of claim 10, wherein each container contains a substantially identical amount of the composition.

12. The article of claim 10, wherein the plurality of disposable containers are joined end to end in a chain.

13. A method for disposing a waste of an animal, the method comprising: contacting the waste with a composition from a disposable container, wherein the composition comprises one or more absorbents, the total amount of the one or more absorbents is effective to absorb moisture from the waste; and placing the contacted waste in the container.

14. The method of claim 13, wherein the container is a bag.

15. The method of claim 14 further comprising inverting the bag inside-out subsequent to contacting the waste with the composition.

16. The method of claim 13, wherein the one or more absorbent is selected from the group consisting of sawdust, alfalfa meal, sand, and mixtures thereof.

17. The method of claim 16, wherein the composition further comprises sodium bicarbonate.

18. The method of claim 17, wherein the composition comprises an absorbent to sodium bicarbonate weight ratio of about 10 to about 0.1.

19. The method of claim 17, wherein the weight ratio of saw dust to alfalfa meal to sodium bicarbonate in the composition is about 1:1:0.5.
